(19) United States
(12) Patent Application Publication
(10) Pub. No.: US 2012/0119496 A1
(43) Pub. Date: May 17, 2012

(54) Wind Turbine Having A Device For Minimizing Loads

(75) Inventor: Sonke Siegfriedsen, Rendsburg (DE)

(73) Assignee: AERODYN ENGINEERING GMBH, Rendsburg (DE)

(21) Appl. No.: 13/377,078

(22) PCT Filed: Jul. 29, 2010
(86) PCT No.: PCT/DE10/00887

§ 371 Date: Dec. 8, 2011

(30) Foreign Application Priority Data
Aug. 7, 2009 (DE) 10 2009 036 517.6

(51) Int. Cl. H02P 9/04

(52) U.S. Cl. 290/44

(57) ABSTRACT

A wind turbine comprising a tower, an energy conversion unit arranged on the tower, a rotor, which is connected to the energy conversion unit and has two rotor blades fastened to a hub, a measuring system arranged in the hub for measuring the mechanical deformation of the hub, and an individual blade controller for setting the blade pitch angle of the rotor blades. The measuring system is designed to detect the distance between two defined locations opposite each other in the hub, and the individual blade controller is designed to set the blade pitch angle of both rotor blades, on the basis of the distance measured between the defined locations or the distance change measured between the defined locations, in such a way that a minimum rotor pitch torque M_{YR} results.

The invention relates to a wind turbine comprising a tower, an energy conversion unit arranged on the tower, a rotor, which is connected to the energy conversion unit and has two rotor blades fastened to a hub, a measuring means arranged in the hub for measuring the mechanical deformation of the hub, and an individual blade controller for setting the blade pitch angle of the rotor blades, to reduce the mechanical loading of the components of the wind turbine.

A wind turbine of this type forming the preamble of claim 1 of the present application has already been know from EP 1 243 790 B1. It provides measuring means for detecting instantaneous stresses that are present locally only on a part of the wind turbine, a control unit acting on an apparatus for individual blade adjustment of the rotor blades of a rotor that carries at least one blade being set such that local peaks in the loading of the rotor blades, the hub, the shaft drive and the bearings used are avoided.

The measuring means used in the case of the known wind turbine are strain gauges that are attached to the rotor blade, inside the rotor blade, on the rotor hub or inside the rotor hub, on the stub axle or inside the stub axle, on the drive shaft or inside the drive shaft or on the bearings. In particular the strain gauges attached to the rotor hub are arranged are arranged in the rotor blade plane, flush thereto.

A disadvantage of using strain gauges is the high degree in terms of assembly and maintenance, the measurement inaccuracy due to rather slow measurements and high load cycles and the relatively fast wear of this type of measurement means. Strain gauges are sensitive in terms of mechanical loading, in particular against overstretching, and can separate from the support in the case of a high degree of cyclic loading.

It is therefore known as an alternative from DE 101 60 360 B4 to route a light guide inside the rotor blade and to determine the mechanical loading acting on a rotor blade by comparing the amounts of light entering and leaving, a plant control system being provided that adjusts automatically to relieve the rotor blades.

However a disadvantage of this design is the amount of work involved in routing the light guide during the production of the rotor blades. In addition the light guides are sensitive against mechanical loading—like the strain gauges—and in principle are measuring means of low reliability in the area of load determination of components of wind turbines due to the risk of being damaged by mechanical loading.

Other devices have therefore become known recently for determining loads that act on rotor blades, e.g. DE 20 2007 008 066 U1 and DE 10 2006 002 708 B4. They provide a laser measuring device that is arranged in the hub of the wind turbine and emits light into the rotor blades, it being possible for deflections of the rotor blades to be detected by the deviation of the laser beam from reference points arranged in the blades or by means of deviations of the reflected light and for excessive loads occurring on the blades to be avoided by suitable control mechanisms.

A disadvantage is again the high degree of work when setting up the measurement system, in particular the increased degree of work involved in the production of the rotor blades.

The conventional wind turbines that are designed for high operational stability loads mostly have a high weight due to the high degree of material consumption, the high degree of material consumption entailing a corresponding complex production of the components of the wind turbine, complex transport and complex erection.

It is therefore the objective of the present invention to create a simple, fast reacting and easy to install measurement system for wind turbines that enables operation of a wind turbine such that the operational stability loads are minimized and therefore a more light-weight and material-saving structure can be designed.

The objective is achieved by the wind turbine having the features of claim 1. The sub claims represent advantageous designs of the invention.

The basic idea of the invention is to detect the uneven load distribution, caused for example by turbulence and resulting in a bending moment M_{YR} transverse to the orientation of the blade axis, at the mutual opposite rotor blades of a twin-bladed rotor by means of the deformation occurring at the hub and to vary the blade pitch angle of the blades such that the blade-connecting moments add up to a differential moment as low as possible

The invention is explained in more detail using an exemplary embodiment of particularly preferred design illustrated in the drawings. In the drawing:

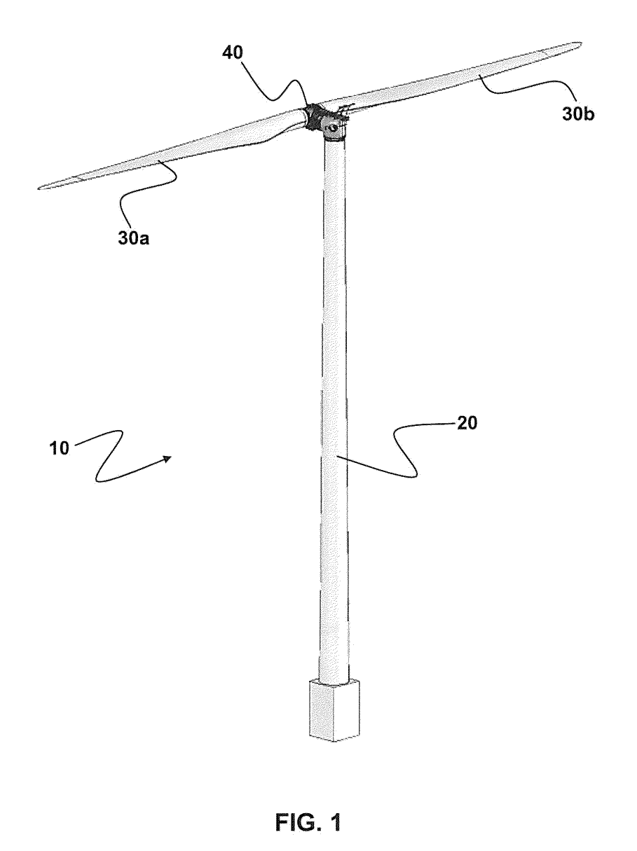

FIG. 1 shows a perspective view of a wind turbine having a twin-bladed rotor;

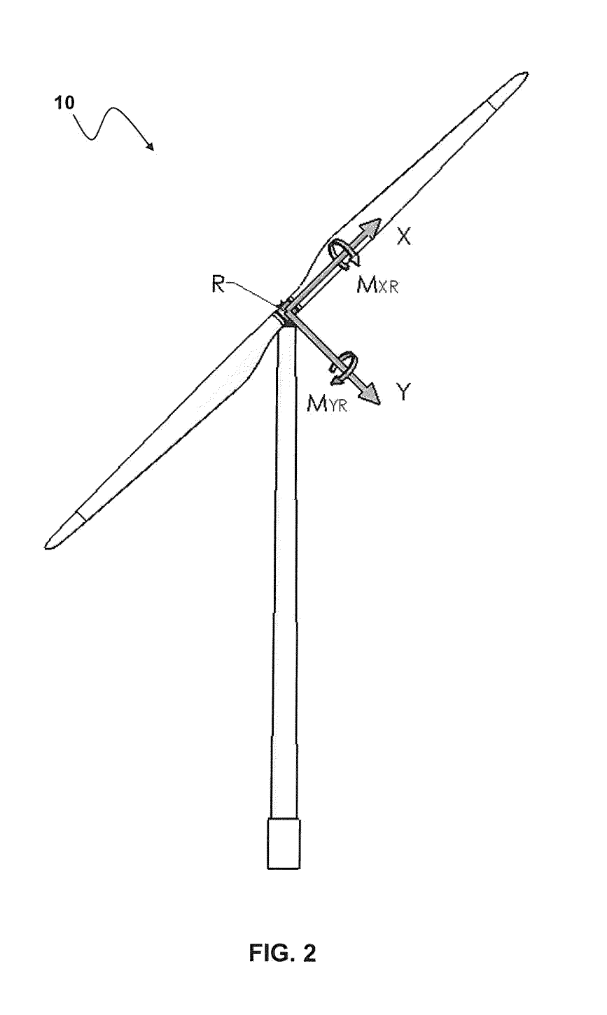

FIG. 2 a front view of the wind turbine from FIG. 1 with the designation of the axes X and Y and the moments M_{YR} and M_{XR} in the R coordinate system rotating together with the rotor;

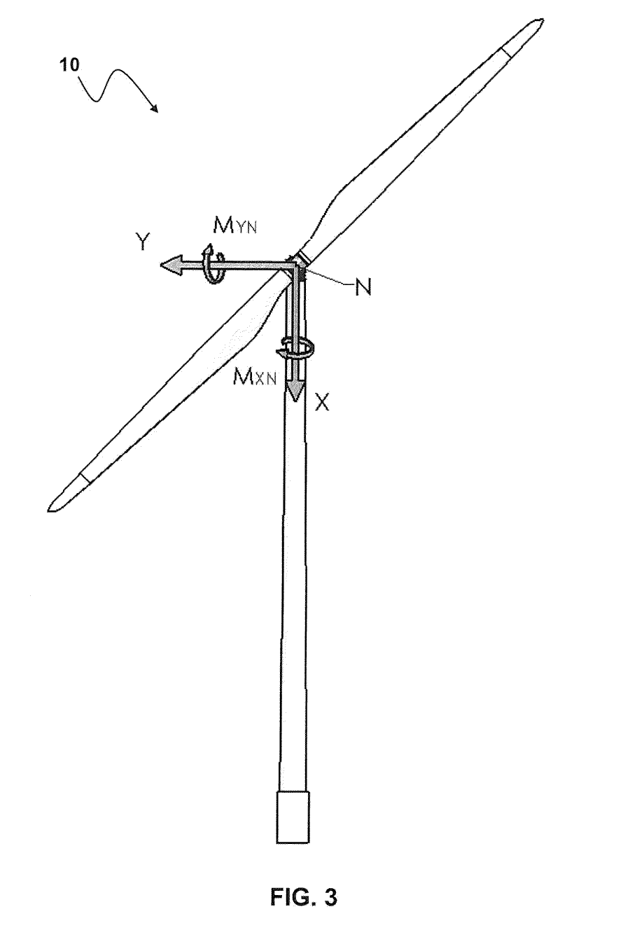

FIG. 3 a front view of the wind turbine from FIG. 1 with the designation of the axes X and Y and the moments M_{YN} and M_{XN} in the stationary N coordinate system;

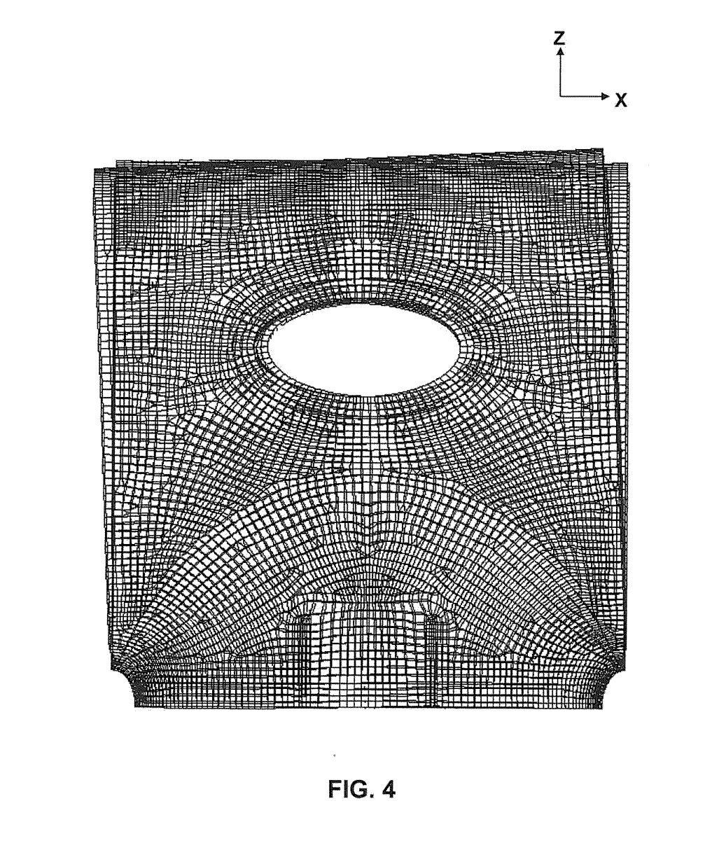

FIG. 4 an illustration of the deformations occurring at the hub;

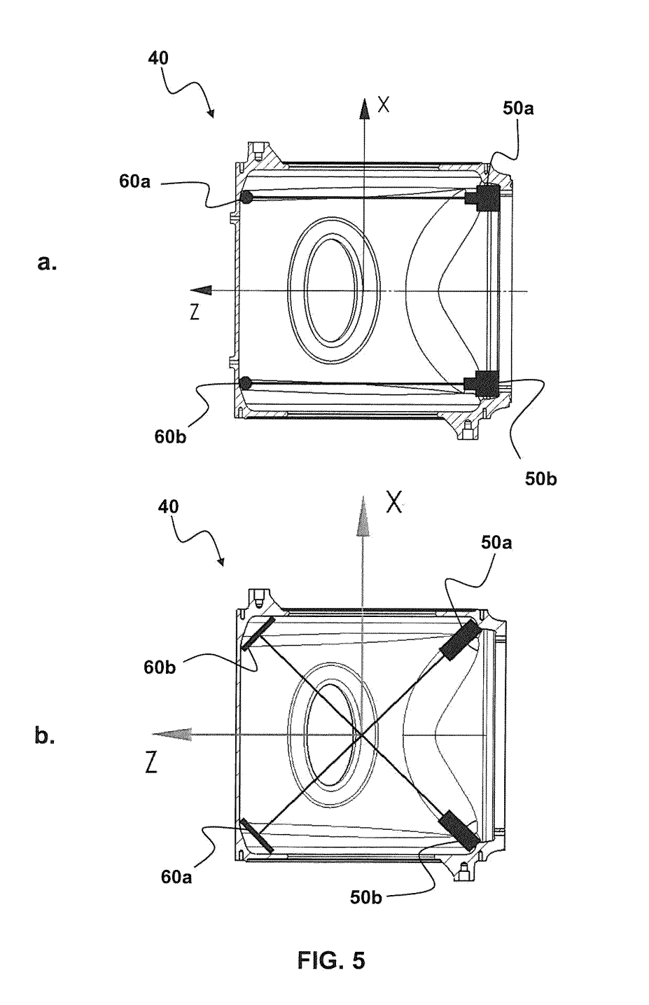

FIG. 5 (a) a cut side view of the hub of the wind turbine from FIG. 1 according to an exemplary embodiment and (b) a cut side view of the hub of the wind turbine from FIG. 1 according to an exemplary embodiment;

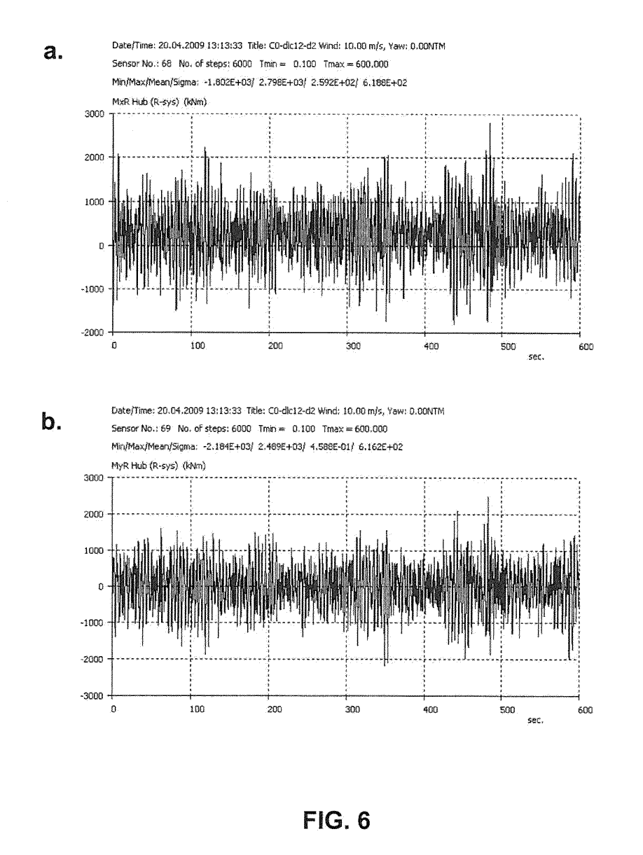

FIG. 6 the time curve of the bending moments M_{XR} (a) and M_{YR} (b) occurring at the hub in an unregulated wind turbine in the R-coordinate-system-3-blade rotor co-rotating with the rotor;

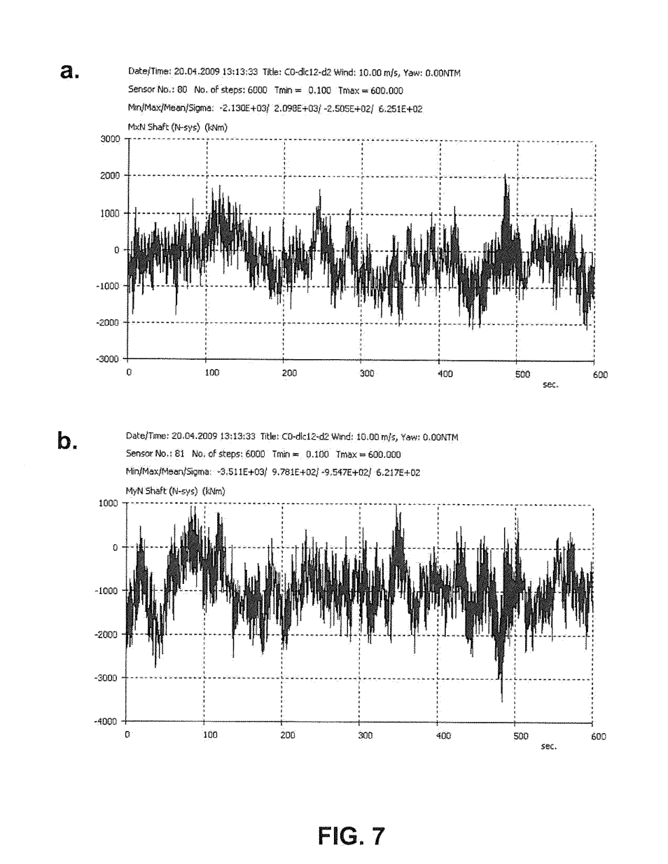

FIG. 7 the time curve of the bending moments M_{XN} (a) and M_{YN} (b) occurring at the hub in an unregulated wind turbine in the stationary N-coordinate system-3-blade rotor;

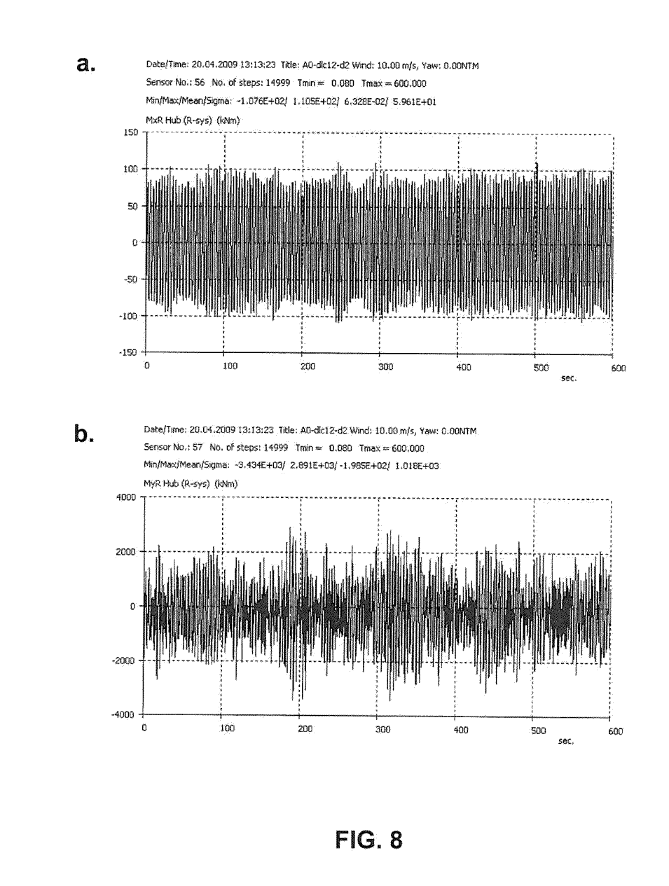

FIG. 8 the time curve of the bending moments M_{XR} (a) and M_{YR} (b) occurring at the hub in a wind turbine according to the invention in the R-coordinate-system-2-blade rotor co-rotating with the rotor; und

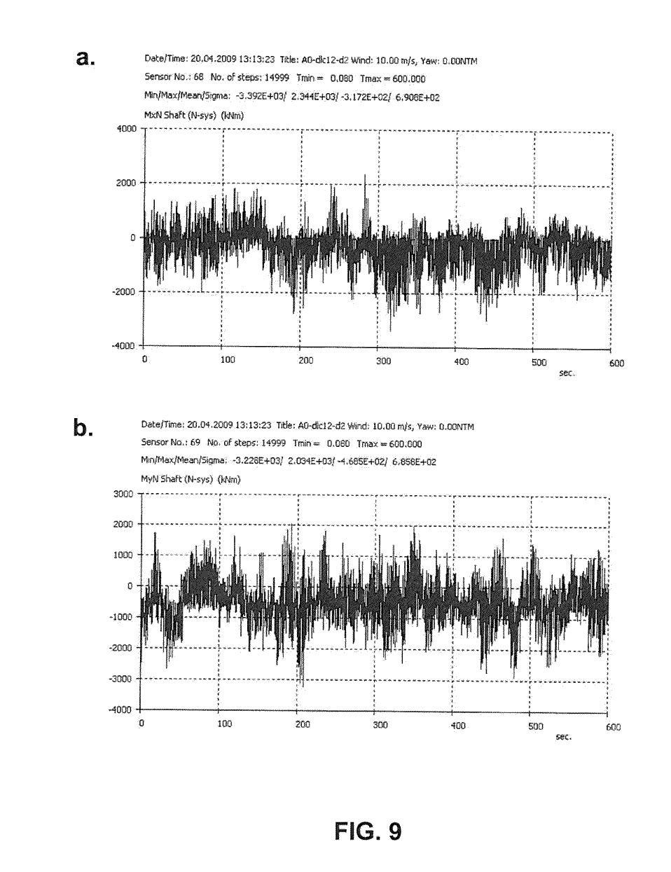

FIG. 9 the time curve of the bending moments M_{XN} (a) and M_{YN} (b) occurring at the hub in a wind turbine according to the invention in the stationary N-coordinate system-2-blade rotor.

FIG. 1 shows a wind turbine suitable for implementing the invention in a perspective view. The wind turbine 10 consists of a tower 20, a head carrier (without reference numeral), arranged on the tower, or a nacelle in which carrier or nacelle the energy conversion unit is arranged, and a rotor connected to the energy conversion unit that exhibits two rotor blades 30a, 30b attached to a hub 40.

FIG. 2 clarifies the position of the bending moments M_{XR} und M_{YR} acting in the R coordinate system co-rotating with the rotor R on the hub, occurring along the blade axis X and the axis Y co-rotating about the rotor axis.

FIG. 3 clarifies the position of the bending moments M_{XN} und M_{YN} acting in the stationary N coordinate system on the hub 40 or N, occurring along the vertical axis X and the horizontal axis Y.

FIG. 4 shows the deformation plot of a hub in the normal state and the state deformed under load in a superposed representation exaggerated by an enhancement factor of 300. It shows that due to the y bending moment, deformation of the hub in the direction of the X axis also leads to a measurable change in length of the hub in the direction of the Z axis.

This change in length in the direction of the Z axis can be used as input quantity for varying the blade pitch angle to reduce the moment MYR. To this end FIGS. 5a, b each show a section through the hub 40 in an inventive wind turbine 10 in the X/Z plane (of the R coordinate system co-rotating with the rotor). There are positioned in the hub 40 in defined locations that lie opposite in the hub interior, preferably a plurality of measuring means 50a, 60a, 50b, 60b that can be used to detect the distance of the defined locations relative to each other or a distance change due to the bending moments leading to a deformation of the hub 40, or a relative displacement between the defined locations.

To this end for example a laser measurement device can be used, in particular a laser ranging device, where for example a transmitting/receiving device 50a, 50b is arranged opposite a reflector or detector 60a, 60b. Alternative solutions, e. g. by means of ultrasound or induction measurement of elements braced in the hub interior that can change their position, are conceivable as long as detection of hub deformations is guaranteed. Measurement systems are preferred with a resolution in the range of one hundredth of a millimetre so that load reducing feedback control can be made possible that responds to even small deformations.

It is preferred that the measuring means 50a, 60a, 50b, 60b are arranged—as shown—in the plane of the rotor blades 30a, 30b (not shown in FIGS. 5a, b), the measuring means 50a, 60a, 50b, 60b being arranged for example in defined locations that lie opposite each other in the hub 40 in the longitudinal direction (cf. FIG. 5a). In this way deformation of the hub in the direction of the Z axis can be detected for example by the distance change of the measuring means 50a/60a, 50b/60b that lie opposite each other—as shown in FIG. 5a—or—as shown in FIG. 5b—by detection of the shift of the mutually opposite reference points in the direction of the X axis at measuring means 60a, 60b designed as detectors. As an example a measuring means 60a, 60b designed as a (CCD) camera can be used in the case mentioned last that detects a measuring means 50a, 50b that is formed as a light emitting diode, deformation of the hub 40, that is to say a local change in length of the hub in the Z direction, triggering a shift of the camera in the X direction, so that the light of the light emitting diode 50a, 50b hits an area of the camera sensor that is unexposed in the undeformed state of the hub and the change in length of the hub in the Z direction can be inferred from the shift.

The individual blade controller is now generally adjusted such due to the distance between the defined locations, detected using the measuring means, or the detected distance change of the defined locations relative to each other the blade pitch angle of one or both rotor blades 30a, 30b is adjusted so that the difference of the blade-connecting moments acting on the hub 40 assumes a value, preferably averaged over time, that is as low as possible. So for example one of the rotor blades 30a, 30b that has a high bending moment is brought into a position in which the bending moment caused by the one rotor blade is reduced and/or the other rotor blade is brought into a position in which the bending moment caused by the other rotor blade is increased, with the proviso that the difference from the bending moments of the two rotor blades results in a rotor pitch torque M_{YR} that is as small as possible.

Particularly preferred the adjustment of the blade pitch angle of the rotor blades 30a, 30b takes place taking into account the difference angle assumed by the rotor blades, it being possible for example to predetermine that a certain difference angle must not be exceeded. In particular it is provided that for high wind speeds only a small difference angle may occur, however for low wind speeds a large difference angle may occur. In the process in particular it is always the rotor blade having the higher load that is to be adjusted first such that a rotor pitch torque that is as low as possible is present at the adjusted blade itself, but also a lesser load.

The blade pitch angle is preferably adjusted by means of a hydraulic device that can react to peak loads that occur at short notice, very quickly, in particular in connection with the measuring means that is preferably designed as a laser measuring system. In contrast to electrical adjusting devices that do not achieve fast feedback control due to the mass inertia of the installation parts, hydraulic control, when the stores are designed accordingly, not only achieves a high speed but also a large acceleration of the control of the blade pitch angle.

To illustrate the preliminary considerations that are the basis of the invention, FIG. 6 and FIG. 7 show the time curve of the bending moments M_{XR} (FIG. 6a) and M_{YR} (FIG. 6b) occurring at the hub of a 3 blade rotor of a conventional unregulated wind turbine according to the prior art in the R coordinate system co-rotating with the rotor and of the bending moments M_{XN} (FIG. 7a) and M_{YN} (FIG. 7b) in the stationary N coordinate system.

In particular FIG. 6 shows that both in the case of the bending moment M_{XR} and in the case of the bending moment M_{YR} high load peaks>2.000 kNm can briefly occur that require according to the prior art the wind turbine parts to be designed for such high operational stability loads. On account of the loadings occurring in several directions FIG. 7 here shows a non-uniform time curve of the bending moments M_{XN} (FIG. 7a) and M_{YN} (FIG. 7b) acting on the hub, the approximately identical bending moments M_{XR} (FIG. 6a) and M_{YR} (FIG. 6b) shown in FIG. 6, of the rotating R coordinate system having a direct effect on the strong fluctuations of the bending moments M_{XN} (FIG. 7a) and M_{YN} (FIG. 7b).

In contrast varying the load conditions of a conventional twin-bladed rotor known from the prior art is clearer, simpler and more effective since essentially only moments occur at right angles to the blade axis, the moments around the blade axis (M_{XR}) being smaller by a factor of approximately 10-20 than for 3-blade installations. Varying a twin-bladed installation is therefore essentially only a one-dimensional problem; in contrast varying a 3-blade installation is a two-dimensional problem (that can hardly be varied or badly). There results in particular from a moment M_{XR} in the rotating R coordinate system (cf. FIG. 8a) acting on the hub and reduced relative to a 3-blade rotor by a factor of 10 to 20, a moment M_{YN}, shown in FIG. 9a, in the stationary N coordinate system that acts on the hub and is strongly reduced averaged over time.

Using the load reducing feedback control suggested according to the invention for a twin-bladed rotor results as the advantage of the present invention in particular that component-sized bending loads can be reduced permanently with the effect of substantial savings in terms of material and thus costs in the production of heavily stressed wind turbine components, e. g. rotor hub, rotor shaft, bearing, bearing housing and main frame.

To guarantee the operational safety it is finally provided that the load spectra are measured, it also being possible to detect the peak values. To monitor the effect of the inventive load reducing feedback control and thus the functioning of the load reducing feedback control itself it is additionally provided that the control is switched off for a certain period, in predetermined intervals and/or in the case of predetermined environmental conditions e. g. certain wind speeds, although the deformations occurring at the hub continue to be measured. A comparison of a predetermined period with the control switched off with an equally long period with a control switched on reveals the effectiveness of the control and the operational safety of the plant (if the control should have failed for example because of a defect).

This check that is repeated in intervals is suitable as proof that the inventive load reducing feedback control functions properly—in case there are no differences between the loads occurring in the different periods at the hub, the wind turbine is to be switched off or its power is to be limited since it is mandatory to avoid the case where the plant is really exposed to higher loads than those maximum loads for which the wind turbine is not designed. In each case a warning report is to be issued to the facility monitoring the plant.

By recording the load spectra and comparison with the design of the wind turbine it is finally possible to determine the maximum operating time of the plant that is predetermined by the operational safety, it being possible for the actual operating time of the plant to be shortened or also lengthened according to the loads actually occurring. In each case better use of the material is possible as a result of such monitoring.

1. A wind turbine comprising
a tower,
an energy conversion unit arranged on the tower,
a rotor, which is connected to the energy conversion unit and has two rotor blades fastened to a hub,
a measuring means arranged in the hub for measuring the mechanical deformation of the hub, and
an individual blade controller for setting the blade pitch angle of the rotor blades,
characterized in that
the measuring means is configured to detect a distance between two defined locations opposite each other in the hub, and
the individual blade controller is configured to set the blade pitch angle of both rotor blades, on the basis of the distance measured between the defined locations or a distance change measured between the defined locations, in such a way that a minimum rotor pitch torque M_{YR} results.

2. The wind turbine according to claim 1, characterized in that the defined locations opposite each other are arranged in a plane formed by the rotor blades and a rotor axis.

3. The wind turbine according to claim 1, characterized in that the defined locations are arranged in the hub parallel to a rotor axis.

4. The wind turbine according to claim 1, characterized in that the defined locations are in positions diagonally opposite in the hub.

5. The wind turbine according to claim 1, characterized in that the measuring means is a laser measuring device.

6. The wind turbine according to claim 1, characterized in that the measuring means exhibit an illuminant and a camera detecting the position of the illuminant.

7. The wind turbine according to claim 1, characterized in that the individual blade controller is designed to effect a minimum rotor pitch torque M_{YR} taking into account a difference angle of the rotor blades.

8. The wind turbine according to claim 7, characterized in that the difference angle of the rotor blades is controlled as a function of wind speed.

9. In a wind turbine including a tower, an energy conversion unit arranged on the tower, a rotor which is connected to the energy conversion unit and has two rotor blades fastened to a hub, a measuring means arranged in the hub for measuring the mechanical deformation of the hub, and an individual blade controller for setting the blade pitch angle of the rotor blades, a method of setting blade pitch angles comprising:
detecting, with the measuring means, a distance between two defined locations opposite each other in the hub; and
setting, through the individual blade controller, the blade pitch angle of both rotor blades on the basis of the distance measured between the defined locations or a distance change measured between the defined locations, in such a way that a minimum rotor pitch torque M_{YR} results.

10. The method of claim 9, characterized in that the defined locations opposite each other are arranged in a plane formed by the rotor blades and a rotor axis.

11. The method of claim 9, characterized in that the defined locations are arranged in the hub parallel to a rotor axis.

12. The method of claim 9, characterized in that the defined locations are in positions diagonally opposite in the hub.

13. The method of claim 9, further comprising: utilizing a laser measuring device as the measuring means.

14. The method of claim 9, further comprising, in connection with the measuring means, exhibiting an illuminant and utilizing a camera to detect a position of the illuminant.

15. The method of claim 9, further comprising: effecting a minimum rotor pitch torque M_{YR} taking into account a difference angle of the rotor blades.

16. The method of claim 15, further comprising: controlling the difference angle of the rotor blades as a function of wind speed.)
